(19) United States
(12) Patent Application Publication
(10) Pub. No.: US 2020/0284231 A1
(43) Pub. Date: Sep. 10, 2020

(54) VALVE, IN PARTICULAR SUCTION VALVE, IN A HIGH-PRESSURE PUMP OF A FUEL INJECTION SYSTEM

(71) Applicant: Robert Bosch GmbH, Stuttgart (DE)

(72) Inventors: Andreas DUTT, Stuttgart (DE); Minzhi XIA, Ostfildern-Kemnat (DE); Stefan KOLB, Gaertringen (DE); Steffen HOLM, Stuttgart (DE); Tobias LANDENBERGER, Schorndorf (DE)

(21) Appl. No.: 16/063,449

(22) PCT Filed: Oct. 24, 2016
(86) PCT No.: PCT/EP2016/075531

§ 371 Date: Jun. 18, 2018

(30) Foreign Application Priority Data
Dec. 17, 2015 (DE) 10 2015 225 770.3

(51) Int. Cl. F02M 59/46; F02M 59/36; F04B 7/00

(52) U.S. Cl. CPC F02M 59/466; F02M 2200/8061; F04B 7/0076; F02M 59/367

(57) ABSTRACT

The invention relates to a valve, in particular a suction valve, in a high-pressure pump of a fuel injection system, having a valve element (14) which can be moved between an open position and a closed position and which is connected to a magnet armature (10) via an armature pin (8). An actuation force can be transmitted to the valve element (14) by the armature pin (8). The invention is characterized in that the armature pin (8) is partly introduced into a depression (24) of the magnet armature (10), and the armature pin (8) and the magnet armature (10) are connected together in a contact region (48) in a force-fitting manner by means of an interference fit (20). The armature pin (8) has a changing outer diameter (47), in particular a continuously changing outer diameter, along the contact region (48).

### BACKGROUND OF THE INVENTION

The invention relates to a valve, in particular a suction valve, particularly in a high-pressure pump of a fuel injection system, which comprises a valve element that can be moved between an open position and a closed position, having an armature which is in mechanical contact with the valve element via an armature pin, wherein the armature pin is connected to the armature by means of a press fit, wherein an actuating force can be transmitted to the valve element by the armature pin. The invention further relates to a pump, in particular a high-pressure pump of a fuel injection system, in which the suction valve is inserted. The invention furthermore relates to a method for producing a valve.

A solenoid-operated suction valve for a high-pressure pump of a fuel injection system, in particular a common-rail injection system, is disclosed by DE 10 2013 220 593 A1. This document furthermore discloses a high-pressure pump having such a suction valve.

The suction valve comprises a valve element that can be moved between an open position and a closed position and is at least indirectly in contact with an armature via an armature pin. An actuating force can therefore be transmitted to the valve element by the armature. The high-pressure pump comprises a pump housing having a housing part in which a reciprocating pump plunger is fitted in a cylinder bore and defines a pump working chamber in the cylinder bore. The pump working chamber can be connected via the suction valve to a fuel feed and via a non-return valve to a high-pressure fuel accumulator.

The armature is part of an electromagnetic actuator, which also comprises a solenoid. When the solenoid is energized, a magnetic field is formed, causing the armature to move relative to the solenoid against a spring force, in order to close the working air gap.

### SUMMARY OF THE INVENTION

The valve according to the invention, the pump according to the invention and the method according to the invention have the advantage over the prior art that the armature pin is partially introduced into a depression in the armature, and the armature pin and the armature are non-positively connected together by means of a press fit in a contact area, and that the armature pin has a varying, in particularly continuously varying outside diameter along the contact area. This serves to prevent damaging of the armature due to an uneven voltage distribution and the overall surface in the area of the press fit is increased. The connection between the armature and the armature pin thereby has increased cohesion and therefore greater strength, which in turn has the advantage of increasing the mechanical load-bearing capacity and therefore prolonging the service life of the suction valve and hence of the high-pressure pump as a whole.

The armature advantageously has a varying inside diameter in the area of the depression along the contact area. In this way the overall surface in the area of the press fit is enlarged and the cohesion between the armature and the armature pin can therefore be increased, which leads to an increased mechanical load-bearing capacity.

A further advantage is that the outside diameter of the armature pin diminishes along the contact area in the direction of the depression in the armature. This serves on the one hand to increase the overall surface of the press fit and therefore the cohesion between the armature and the armature pin, which leads to an increase in the mechanical load-bearing capacity. On the other hand, this advantageous form of the armature pin makes it possible to improve and to simplify the assembly process, since this form improves the guidance during the assembly process and the risk of the armature pin component tilting is reduced. This reduces the risk of a mishap during assembly and any possible prior damaging of the armature pin and armature components due to tilting during the assembly process is reduced, which in turn leads to reduced costs.

The outside diameter of the armature pin advantageously increases along the contact area in the direction of the depression in the armature. This increases the surface of the press fit formed whilst at the same time reducing the surface stress per unit area on the armature pin component. This results in an improved distribution of stresses on the component and therefore a reduced risk of material fatigue and of the component failing.

In addition, a further advantage of the development according to the invention is that the inside diameter of the armature increases in the area of the depression along the contact area in the direction of the armature pin. This serves on the one hand to increase the overall surface of the press fit and therefore the cohesion between the armature and the armature pin, which leads to an increase in the mechanical load-bearing capacity and therefore to an increase in the service life of the valve and consequently of the pump. On the other hand, this advantageous form of the armature pin makes it possible to improve and to simplify the assembly process, since this form improves the guidance during the assembly process and reduces the risk of the armature pin component tilting. The risk of a mishap during assembly is thereby reduced and any possible incipient damaging of the armature pin and armature components due to tilting during assembly is reduced, which in turn leads to reduced costs.

It is moreover advantageous for the variation in the outside diameter of the armature pin and/or the variation in the inside diameter of the armature in the area of the depression to have a linear profile. This makes it possible to match the armature and armature pin components in the contact area of the press fit to one another in such a way that the press fit develops a maximum cohesion, whilst minimizing the fitting force required. In addition, the variation in the outside diameter of the armature pin and/or the variation in the inside diameter of the armature in the area of the depression advantageously has a curved profile. This allows a further increase in the surface in the area of the press fit formed. This further enlargement of the surface serves to increase the cohesion between the armature component and the armature pin yet further.

The armature pin with the outside diameter varying in the direction of the longitudinal axis [is advantageously introduced into the depression in the armature], which at least in respect of a portion of the part of the armature pin to be introduced into the depression, has a small inside diameter in proportion to the outside diameter of the armature pin, wherein the depression in the armature is expanded before, during or after the introduction of the armature pin, in order to form a non-positive connection through a press fit in the contact area with the armature pin. This advantageous form of the method makes it possible either to reduce the fitting force that is needed in order to introduce the armature pin into the depression in the armature to a very much smaller value than is needed without the use of this method, or to eliminate the fitting force altogether.

Furthermore, the inside diameter of the armature in the contact area is advantageously increased before pushing in the armature pin, wherein the process of enlarging the inside diameter is, in particular, reversible and done for a limited time and the inside diameter elastically returns again following insertion of the armature pin.

This advantageous form means that after inserting the armature pin into the depression in the armature with a greatly reduced fitting force—as described in the preceding paragraph—it is possible for the inside diameter to diminish again and to return to its original shape. Joining of the armature pin and the armature is therefore possible with a greatly reduced force, if any, and the compression occurs under the subsequent equalization of temperature, wherein the surface roughness is very largely retained, resulting in a firm seating of the press fit.

In a further advantageous form of the method for producing a valve the inside diameter of the armature is enlarged, in particular, by a thermal process. This makes it possible to reduce the fitting forces during assembly and to bring the assembly costs down.

A further advantage of the development of the method according to the invention is that the outside diameter of the armature pin is reduced by a thermal process, in particular by cooling, particularly in the area which forms the press fit, wherein the process of reducing the outside diameter is reversible and done for a limited time. This development of the method according to the invention makes it possible to reduce the fitting force required and therefore the energy needed during assembly, which in turn reduces the assembly costs.

### BRIEF DESCRIPTION OF THE DRAWINGS

Various exemplary embodiments of the invention are represented in the drawings and explained in more detail in the following descriptions. In the drawings:

FIG. 1 shows a pump in a longitudinal section,

FIG. 2 shows an enlarged representation of a detail of the pump, denoted by II in FIG. 1, having a suction valve,

FIG. 3 shows an enlarged representation of a detail of the suction valve, denoted by III in FIG. 2.

FIG. 4 shows a section of the armature according to a first exemplary embodiment.

FIG. 5 shows a section of the armature according to a second exemplary embodiment.

FIG. 6 shows a section of the armature according to a third exemplary embodiment.

FIG. 7 shows a section of the armature pin according to a first exemplary embodiment.

FIG. 8 shows a section of the armature pin according to a second exemplary embodiment.

FIG. 9 shows a section of the armature pin according to a third exemplary embodiment.

FIG. 10 shows a section of the armature pin according to a fourth exemplary embodiment.

FIG. 11 shows a section of the armature pin according to a fifth exemplary embodiment, which corresponds to the prior art.

FIG. 12 shows a method according to the invention for joining the armature and armature pin components.

### DETAILED DESCRIPTION

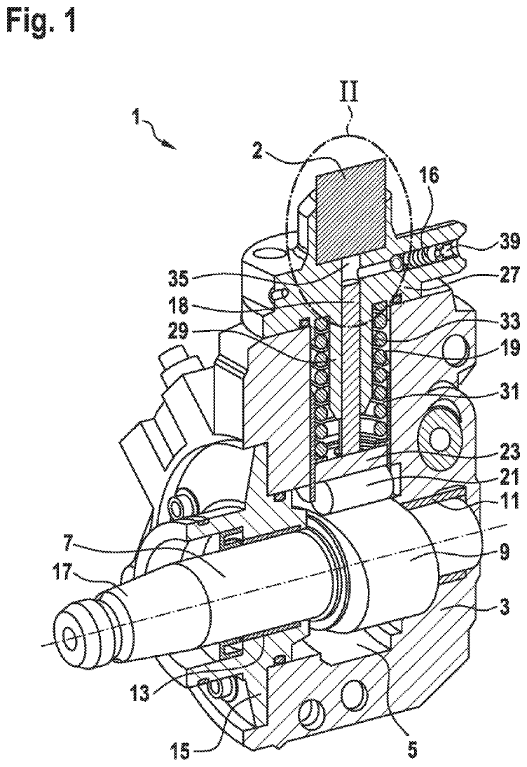

FIG. 1 shows a sectional representation of a schematically represented high-pressure pump 1, which is embodied as a high-pressure fuel pump and is preferably fitted in a common-rail injection system. The high-pressure pump 1 delivers fuel provided from a low-pressure fuel system, which comprises at least a tank, a filter and a low-pressure pump, into a high-pressure accumulator, from where the stored fuel is drawn by fuel injectors for injection into assigned combustion chambers of an internal combustion engine. The fuel is fed to the pump working chamber via a solenoid-operated suction valve 2, wherein the solenoid-operated suction valve is fitted to the high-pressure pump.

The high-pressure pump 1 comprises a pump housing 3 having a camshaft chamber 5. A camshaft 7 having a cam 9 in the form of a double cam, for example, extends into the cam chamber 5. The camshaft 7 is supported in two radial bearings arranged on both sides of the cam 9. The one bearing is a housing bearing 11 arranged in the pump housing 3 and the second bearing is a flange bearing 13. The flange bearing 13 is arranged in a flange 15, which is connected to the pump housing 3 and which tightly seals off the camshaft chamber 5 from the surroundings. The flange 15 has a through opening, through which a drive-side end portion 17 of the camshaft 7 extends. The drive-side end portion 17 has a taper, for example, onto which a drive wheel is mounted and secured. The drive wheel takes the form, for example, of a belt pulley or a gear wheel. The drive wheel is driven directly by the internal combustion engine or indirectly via a belt drive or a gear mechanism, for example.

A tappet guide 19, into which a roller tappet 23 comprising a roller 21 is inserted, is furthermore let into the pump housing 3. The roller 21 runs on the cam 9 of the camshaft 7 as the latter rotates and the roller tappet 23 is therefore moved translationally up and down in the tappet guide 19. In so doing the roller tappet 23 interacts with a pump plunger 18, which is arranged so that it can likewise perform a translational up and down movement in a cylinder bore 29 formed in a pump cylinder head 27. A tappet spring 33, which is supported on the one hand on the pump cylinder head 27 and on the other on the roller tappet 23, and which ensures that the roller 21 continuously bears on the cam 9 in the direction of the camshaft 7, is arranged in a tappet spring chamber 31 formed by the tappet guide 19 and the pump bore 29. A pump working chamber 35, into which fuel is introduced by the solenoid-operated suction valve 2, is formed in the pump cylinder head 27 as an extension of the pump plunger 18. The fuel is introduced during a downward movement of the pump plunger 18, whereas during an upward movement of the pump plunger 18 fuel present in the pump working chamber 35 is delivered via a high-pressure outlet 39 with an outlet valve 16 inserted, via a further high-pressure line into the high-pressure accumulator. The high-pressure pump 1 as a whole is fuel-lubricated, wherein the fuel is delivered from the low-pressure system into the camshaft chamber 5, which is flow-connected to the suction valve 2. This solenoid-operated suction valve 2 and its working principle is described below.

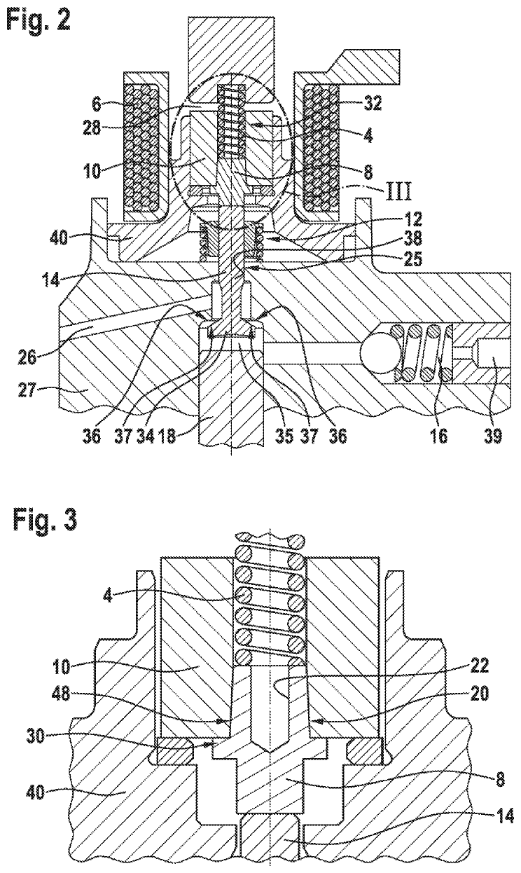

The solenoid-operated suction valve 2 fitted to the high-pressure pump 1 as represented in FIG. 2 comprises a plunger-shaped valve element 14, which is acted upon in the closing direction by the spring force of a second compression spring 12. The plunger-shaped valve element 14 comprises a stem 25, in particular a cylindrically formed stem 25, and an enlarged head 34. The enlarged head 34 of the valve element 14 is arranged on the side facing the pump plunger 18. The pump cylinder head 27 moreover comprises a valve seat 36 in the contact area with the closed valve element 14. The plunger-shaped valve element 14 is guided by the stem 25 in a bore 38 in the pump cylinder head 27 and comprises the head 34 of enlarged diameter compared to the stem 25. A sealing face 37, which in the closed position of the valve element 14 bears on the valve seat 36 in the pump cylinder head 27, is formed on this enlarged head 34 of the valve element 14. The pump working chamber 35 is thereby separated from the fuel feed 26 and fuel cannot flow back.

Also represented in FIG. 2 are the elements of an electromagnetic actuator, which serves to actuate the suction valve 2 of the high-pressure pump 1. This comprises an armature 10 having a cylindrical external contour and a central bore 32. A first compression spring 4, which exerts an axial force on the armature 10 towards the valve element 14, moreover extends into this central bore 32 of the armature 10. The armature 10 is moreover axially guided in its reciprocating motion in a carrier element 40. The armature 10 is surrounded in a radial direction by a solenoid coil 6, which when energized forms a magnetic field and is therefore able to exert a magnetic force on the armature 10. The valve element 14 is in contact with the armature 10 via an armature pin 8, wherein the two elements are not connected to one another in an axial direction but are held in contact with one another only by magnetic forces and spring forces. On the side remote from the valve element 14 the armature pin 8 is connected to the armature 10 in that the armature pin 8 is partially inserted into the armature 10 and is non-positively connected to the armature 10 by means of a press fit 20. The armature 10 and armature pin 8 elements in particular form a contact area 48.

The first compression spring 4 presses on the armature pin 8 and the armature 10 in an axial direction. In an unenergized state the first compression spring 4 ensures that the armature pin 8 acts on the valve element 14 and holds it in an open position. Although the second compression spring 12 acts in opposition to this, since the first compression spring 4 has a greater spring force than the second compression spring 12 the valve element 14 is kept in an open state. Energizing the armature 10 by means of the solenoid coil 6 causes the armature 10 to move away from the valve element 14 against the force of the first compression spring 4, in order to close the working air gap 28. Its moving away causes the armature pin 8 to lose the non-positive contact with the valve element 14, so that the valve element 14 moves towards the closed state under the force of the second compression spring 12. In a fully closed state the valve element 14 bears on the sealing face 37 on the valve seat 36 and seals the pump working chamber 35 off from the fuel feed 26.

With the high-pressure pump 1 in suction mode, the solenoid-operated suction valve 2 is opened and the pump working chamber 35 is connected to the fuel feed 26, so that fuel is delivered to the pump working chamber 35 via the suction valve 2. With the high-pressure pump 1 in delivery mode the fuel delivered to the pump working chamber 35 is compressed and delivered to a high-pressure accumulator (not shown) via the outlet valve 16 arranged in the high-pressure outlet 39. With the high-pressure pump 1 in compression mode, in which the pump plunger 18 moves upward, the suction valve 2 is closed when fuel delivery is to ensue, and seals off the pump working chamber 35 from the fuel feed 26.

The detail III represented in FIG. 3 shows precisely how the armature pin 8 is pressed into the armature 10 in order to form a positively interlocking connection in the form of a press fit 20. In order to allow the formation of the press fit 20 in the contact area 48 between the armature 10 and the armature pin 8, the outside diameter 47 of the armature pin 8 in the contact area 48, at least at one point over its length in the insertion direction (V), must have a larger diameter than the smallest inside diameter 45 of the armature 10 in the contact area.

Also shown is the carrier element 40, which serves as guide and receiving element for the armature 10 and the armature pin 8.

The optional annular shoulder 30, which is in bearing contact with the armature 10 and prevents the armature pin 8 being pressed too far into the armature, is also shown. The annular shoulder 30 ensures that the armature pin 8 cannot be pressed further into the depression 24 in the armature 10. It therefore serves as an assembly aid in order to prevent the armature pin 8 being pressed too far into the armature 10.

The figure also shows that the armature pin 8 has an internal recess 22, which is open on the side facing the armature 10. The armature pin 8, moreover, is in bearing contact with the valve element 14 on the one side, and the armature pin 8 is in bearing contact with the first compression spring 4 on the other side. In particular, the inside diameter 45 of the armature 10 may be expanded prior to fitting of the armature pin 8, in order to ensure an improved and simplified assembly process. This can be ensured, in particular, by a thermal process.

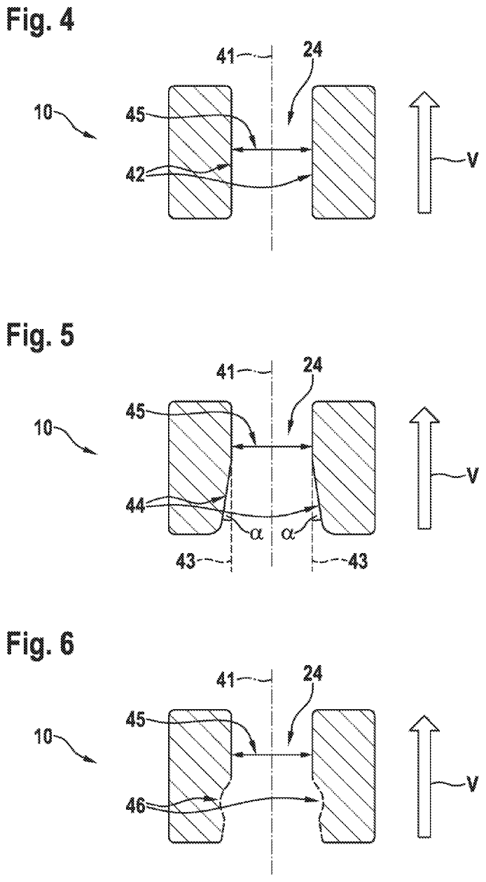

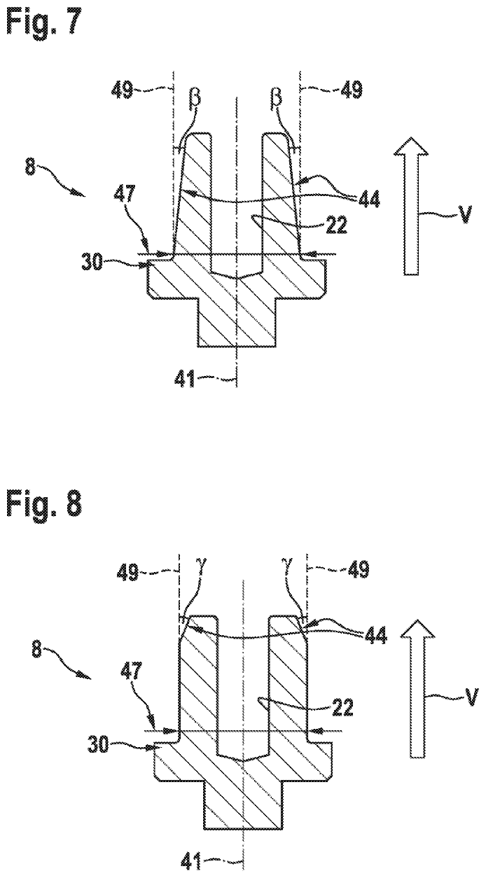

The sectional representations of the armature 10 represented in FIGS. 4, 5 and 6 show different exemplary embodiments of the depression 24 in the armature 10, into which the armature pin 8 is introduced. FIGS. 7 to 10 show sectional representations of the armature pin 8, in which various embodiments of the outside diameter 47 of the armature pin 8 in the area of the press fit 20 are represented.

A center line 41, which at the same time forms the axis of rotation of the sectional representation, is represented in each of the FIGS. 4 to 11. Running parallel to the center line 41 in FIG. 5 are two reference lines 43 and in FIGS. 7, 8 and 9 the two reference lines 49. The reference lines 43 in FIG. 5 run parallel to the center line 41 and as an extension of the line which forms the constant profile of the inside diameter 42 of the armature 10 in the sectional representation. In each of the FIGS. 7, 8 and 9 the reference lines 49 run parallel to the center line 41 and as an extension of the line which forms or would form the constant profile of the outside diameter 47 of the armature pin 8. The center line 41 and the reference lines 43 and the reference lines 49 moreover run parallel to the insertion direction (V) of the armature pin 8.

FIG. 4, as first exemplary embodiment, in a sectional representation of the armature 10 shows that the area of the depression 24 in the armature 10 has a constant profile 42 of the inside diameter 45 over the entire axial length in the insertion direction (V) of the armature pin 8. This shaping of the armature 10 in the contact area 48 of the press fit 20 means that armature 10 does not need to undergo additional finishing work in a further production operation in order to modify the contour of the inside diameter 45 of the armature 10. The geometric shape that serves to improve the formation of the press fit 20 can therefore be shifted into the armature pin 8.

FIG. 5 shows a section of the armature 10 according to a second exemplary embodiment, wherein the armature 10, in the insertion direction (V) of the armature pin 8, has an inside diameter 45 varying over a part of the length, which reveals a linear profile 44. The part of the length of the armature 10 that has a varying inside diameter 45 is the area facing the armature pin 8. The linear profile 44 of the varying inside diameter 45 runs at an angle α to the reference line 43. This exemplary embodiment serves to provide a guide for the armature pin when introducing the armature pin 8 into the recess 22 in the armature 10. This reduces the risk of the armature pin tilting and reduces the fitting force at the beginning of the introduction process.

FIG. 6 represents a section of the armature 10 according to a third exemplary embodiment, wherein the armature 10, in the insertion direction (V) of the armature pin 8, has an inside diameter 45 varying over a part of the length. The part of the length of the armature 10 which has a varying inside diameter 45 is the area facing the armature pin 8. This varying inside diameter 45 has any optional profile, but has a diminishing inside diameter 45 over the entire length in the insertion direction. In particular, this may take the form of a curved profile 46. This design shape of the armature 10 serves decisively to increase the strength of the connection between the armature pin 8 and the armature 10. This applies particularly to the form of the press fit 20 in the contact area 48, so that the effect of the surface roughness of the two elements is exploited to form the press fit 20. This form of the inside diameter 45 of the armature 10 means that the cohesion between the armature 10 and the armature pin 8 can be increased, since the strength of the press fit 20 is increased in the contact area 48.

FIG. 7 shows a section of the armature pin 8 according to a first exemplary embodiment, wherein the armature pin 8, in the insertion direction (V), has an outside diameter 47 which diminishes over the entire length of the contact area 48 of the press fit 20 but which has a linear profile 44. The linear profile 44 of the varying outside diameter 47 runs at an angle θ to the reference line 49. The recess 22 in the armature pin 8 affords further functions described below:

For one thing the recess 22 in the armature pin 8 serves to reduce the weight, which is advantageous, since the armature 10/armature pin 8 assembly performs a high-frequency movement during the operation of the pump 1 and the weight saving afforded by the recess 22 is capable of reducing the inertia of the assembly and in addition can reduce the input energy needed for electromagnetic actuation. The recess 22 in the armature pin 8 moreover affords further advantages during assembly in that it lends the armature pin 8 component a certain elasticity in the area of the press fit 20. This firstly ensures that the fitting force when introducing the armature pin 8 into the depression 24 in the armature 10 is reduced, but secondly after introduction the elasticity ensures that the outside diameter 47 of the armature pin 8 is pressed more heavily against the inside diameter 45 of the armature 10, thereby forming a better non-positive connection in the area of the press fit 20.

FIG. 8 represents a section of the armature pin 8 according to a second exemplary embodiment, wherein the armature pin 8, in the insertion direction (V), has an outside diameter 47 which diminishes over only a part of the length of the contact area 48, but which has a linear profile 44. In FIG. 8 the part that has a diminishing outside diameter 47 extends over less than half of the length of the contact area 48 and is situated on the side of the armature pin 8 facing the armature 10. Over the remaining part of the length of the contact area 48 with the armature 10 the armature pin 8 has a constant outside diameter 47. This small part of the length which has a diminishing outside diameter 47 is situated on the side of the armature pin 8 facing the armature 10. The varying inside diameter 45 runs at an angle γ to the reference line 49. This shaping of the armature pin 8 in the area of the press fit 20 serves to center the armature pin 8 at the beginning of the operation to fit it into the armature 10 and to reduce the risk of tilting or tipping. The second embodiment of the armature pin 8 represented in FIG. 8 furthermore affords the advantage over the embodiment represented in FIG. 7 that a smaller outlay is needed for machining of the component.

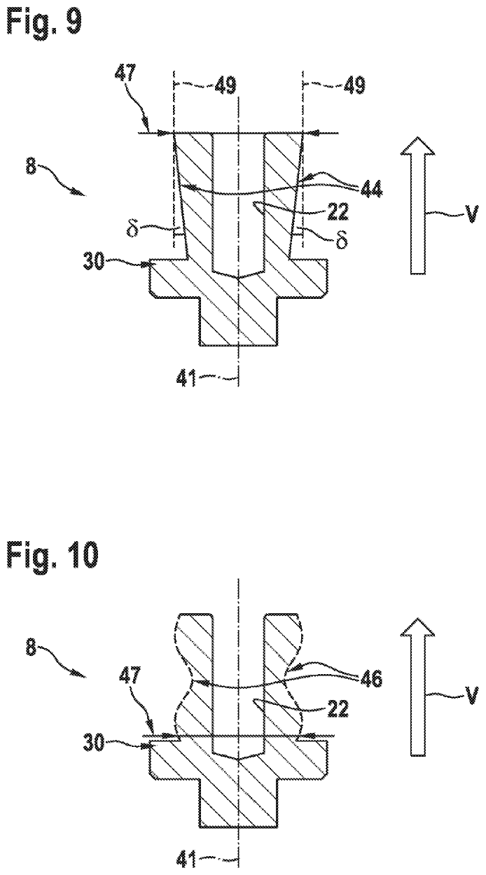

FIG. 9 shows a third exemplary embodiment, showing the section of the armature pin 8. The armature pin 8, in the insertion direction (V), has an outside diameter 47 which increases over the entire length of the contact area 48 and which has a linear profile 44. The varying outside diameter 47 runs at an angle δ to the reference line 43. This exemplary embodiment serves, particularly in combination with the temporary expansion of the inside diameter 45 of the armature 10 undertaken prior to the assembly process, to produce an improvement in the formation of the press fit 20, resulting in a firmer seat.

FIG. 10 shows a section of the armature pin 8 according to a fourth exemplary embodiment, wherein the armature pin 8, in the insertion direction (V), has an outside diameter which varies over the entire length of the contact area 48, but which has a curved, non-linear profile 46. The function of this exemplary embodiment is to enlarge the surface in the area of the press fit 20 and therefore to further increase the cohesion between the armature 10 component and the armature pin 8.

FIG. 11 shows a section of the armature pin according to the prior art. The section of the armature pin 8 shown in FIG. 11 serves as reference and in the prior art is combined with the embodiment of the armature 10 in FIG. 4. This explicit combination of the armature pin 8 in FIG. 11 and the armature 10 in FIG. 4 is therefore not an integral part of the form according to this invention.

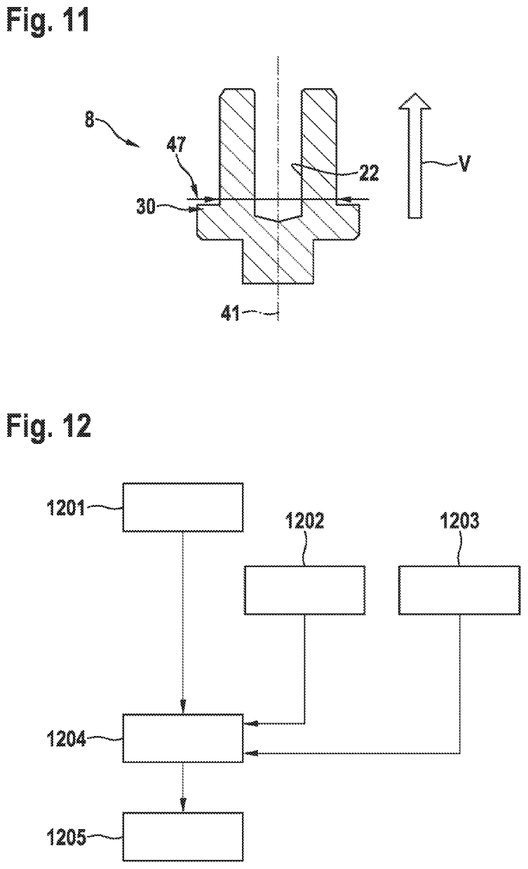

FIG. 12 shows the method according to the invention for joining the armature 10 and armature pin 8 components. The aim of the method is to introduce the armature pin, at least partially, into a depression in the armature and to connect the armature pin and the armature together non-positively in a contact area by means of a press fit. The method 1201 commences by choosing an armature 10 component and an armature pin 8 component, each of any embodiment, as represented in FIGS. 4 to 10. In preparation for the next step 1204, the actual assembly of the two components, particularly by means of an assembly fixture, this may optionally be preceded by the additional steps 1202 and 1203 of the method:

In step 1202 of the method the depression in the armature is expanded before and/or during the introduction of the armature pin 8 into the depression 24 in the armature 10, particularly by a thermal or mechanical process. In particular, the mechanical process is performed through the use of a tool.

In step 1203 of the method the armature pin 8, which is introduced into the depression 24 in the armature 10, is heat-treated. For this purpose, the outside diameter 47 of the armature pin 8 is reduced by a thermal process, in particular by cooling.

This is followed in step 1204 of the method by the actual process of joining the armature 10 and armature pin 8 components. It should be noted with regard to this that the steps 1202 and 1203 of the method can each be employed separately or in combination. Using the steps 1202 and 1203 of the method reduces the fitting force required.

Step 1205 of the method describes the formation of the press fit in the contact area of the armature 10 and the armature pin 8 following assembly in step 1204 of the method. After employing steps 1202 and 1203 of the method, in particular, these are followed, owing to the possible reversibility of the two steps of the method and their temporary nature, by a return movement of either the armature 10 and/or the armature pin 8. This means, in particular, that the press fit 20 between the armature 10 and the armature pin 8 is not formed until step 1205 of the method. Compression therefore occurs, wherein the surface roughness is very largely retained, resulting in a firm seating of the press fit.

1. A valve, which comprises a valve element (14) configured to be moved between an open position and a closed position, an armature (10) which is in mechanical contact with the valve element (14) via an armature pin (8), wherein the armature pin (8) is connected to the armature (10) by a press fit (20), wherein the armature pin is configured to transmit an actuating force to the valve element (14), wherein the armature pin (8) is partially introduced into a depression (24) in the armature (10), and the armature pin (8) and the armature (10) are non-positively connected together by a press fit (20) in a contact area (48), and wherein the armature pin (8) has a varying outside diameter (47) along the contact area (48).

2. The valve as claimed in claim 1, characterized in that the armature (10) has a varying inside diameter (45) in an area of the depression (24) along the contact area (48).

3. The valve as claimed in claim 1, characterized in that the armature (10) has a constant inside diameter (45) in an area of the depression (24) along the contact area (48).

4. The valve as claimed in claim 1, characterized in that the outside diameter (47) of the armature pin (8) diminishes along the contact area (48) in a direction of the depression (24) in the armature (10).

5. The valve as claimed in claim 1, characterized in that the outside diameter (47) of the armature pin (8) increases along the contact area (48) in a direction of the depression (24) in the armature (10).

6. The valve as claimed in claim 1, characterized in that an inside diameter (45) of the armature (10) in an area of the depression (24) increases along the contact area (48) in a direction towards the armature pin (8).

7. The valve as claimed in claim 1, characterized in that variation in the outside diameter (47) of the armature pin (8) and/or variation in an inside diameter (45) of the armature (10) in an area of the depression (24) has a linear profile (44).

8. The valve as claimed in claim 1, characterized in that variation in the outside diameter (47) of the armature pin (8) and/or variation in an inside diameter (45) of the armature (10) in an area of the depression (24) has a curved profile (46).

9. A pump comprising a valve (2) as claimed in claim 1.

10. A method for producing a valve as claimed in claim 1, that the method comprising introducing the armature pin (8) with the outside diameter (47) varying in the direction of the longitudinal axis into the depression (24) in the armature (10), which at least in respect of a portion of a part of the armature pin (8) to be introduced into the depression (24) has a small inside diameter (45) in proportion to the outside diameter (47) of the armature pin (8), wherein the depression (24) in the armature (10) is expanded before or during introduction of the armature pin (8), in order to form a non-positive connection through a press fit (20) in the contact area (48) with the armature pin (8).

11. The method for producing a valve as claimed in claim 10, characterized in that an inside diameter (45) of the armature (10) in the contact area is increased before pushing in the armature pin (8), wherein a process of enlarging the inside diameter (45) is reversible and done for a limited time and the inside diameter (45) elastically returns again following insertion of the armature pin (8).

12. The method for producing a valve as claimed in claim 11, characterized in that the inside diameter (45) of the armature (10) is enlarged.

13. The method for producing a valve as claimed in claim 10, characterized in that the outside diameter (47) of the armature pin (8) is reduced by a thermal process.

14. The valve as claimed in claim 1, characterized in that the armature pin (8) has a continuously varying outside diameter (47) along the contact area (48)

15. The method for producing a valve as claimed in claim 11, characterized in that the inside diameter (45) of the armature (10) is enlarged by a thermal process or by the use of a tool.

16. The method for producing a valve as claimed in claim 10, characterized in that the outside diameter (47) of the armature pin (8) is reduced by cooling in an area which forms the press fit (20), wherein a process of reducing the outside diameter (47) is reversible and done for a limited time.
